(19) United States
(12) Patent Application Publication
(10) Pub. No.: US 2011/0053448 A1
(43) Pub. Date: Mar. 3, 2011

(54) TRIM COVER ASSEMBLY AND A METHOD OF MANUFACTURE

(75) Inventors: Ralf Hobl, Karlshuld (DE); Kevin John Withers, Breitenbrunn (DE)

(73) Assignee: LEAR CORPORATION, Southfield, MI (US)

(21) Appl. No.: 12/824,710

(22) Filed: Jun. 28, 2010

(30) Foreign Application Priority Data
Aug. 28, 2009 (DE) 10 2009 039 178.9

(51) Int. Cl. B32B 27/12; B32B 9/02; D03D 25/00; B32B 3/26; B32B 37/12

(52) U.S. Cl. 442/181; 428/473; 442/287; 442/286; 428/317.1; 442/370; 156/299

(57) ABSTRACT

A trim cover assembly and a method of manufacture are disclosed. The trim cover assembly has a first layer and a second layer. The first layer has a first surface and a second surface disposed opposite the first surface. The second layer is disposed against the second surface. The second layer inhibits plastic deformation of the first layer.

### CROSS-REFERENCE TO RELATED APPLICATIONS

This application claims foreign priority benefits under 35 U.S.C. §119(a)-(d) to DE 10 2009 039 178.9, filed Aug. 28, 2009, which is hereby incorporated by reference in its entirety.

### BACKGROUND OF THE INVENTION

### 1. Field of the Invention

The present invention relates to a trim cover assembly and a method of manufacture.

### SUMMARY OF THE INVENTION

In at least one embodiment, a trim cover assembly is provided. The trim cover assembly includes a first layer and a second layer. The first layer has a first surface and a second surface disposed opposite the first surface. The second layer is bonded against the second surface. The second layer inhibits plastic deformation of the first layer.

In at least one embodiment, a method of making trim cover assembly is provided. The method includes the steps of providing a first layer, a first bonding layer, and a second layer having a polymeric material, positioning the first bonding layer between the first and second layers, and, applying heat and pressure to activate the polymeric material to adhere the first bonding layer to the first and second layers. The second layer and the first bonding layer cooperate to permit elastic deformation of the first layer while inhibiting plastic deformation of the first layer.

In at least one other embodiment a trim cover assembly is provided. The trim cover assembly includes a first layer. A first bonding layer is bonded to the first layer. A second layer is bonded to the first bonding layer. A second bonding layer is bonded to the second layer. A third layer is bonded to the second bonding layer. A third bonding layer is bonded to the third layer. A fourth layer is bonded to the third bonding layer. The second layer and first bonding layer cooperate to inhibit plastic deformation of the first layer. The third and fourth layers provide cushioning.

### BRIEF DESCRIPTION OF THE DRAWINGS

FIG. 1 is a perspective section view of a trim cover assembly.

FIG. 2 is a magnified view of a layer of the trim cover assembly.

FIG. 3 is a flowchart of a method of manufacture of the trim cover assembly.

### DETAILED DESCRIPTION

Detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. In addition, any or all features from one embodiment may be combined with any other embodiment. Therefore, specific structural and functional details disclosed herein are not to be interpreted as limiting, but merely as a representative basis for the claims and/or as a representative basis for teaching one skilled in the art to variously employ the present invention.

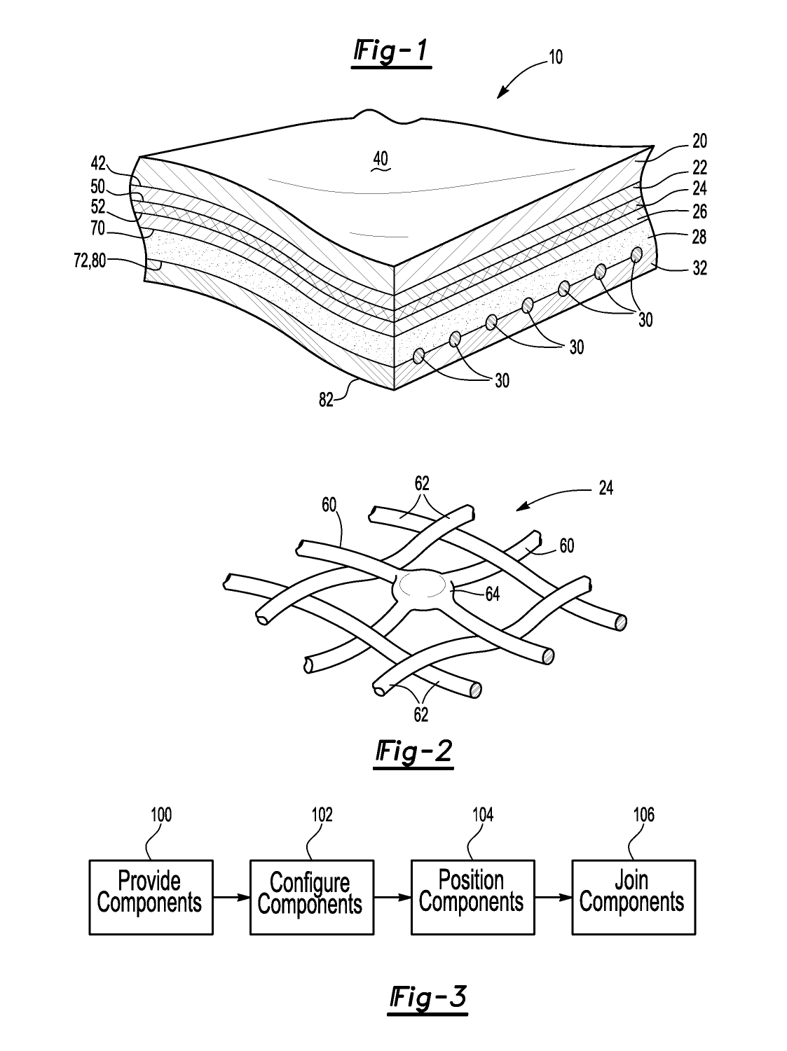

Referring to FIG. 1, a portion of an exemplary trim cover assembly 10 is shown. The trim cover assembly 10 may be configured for use in vehicular or non-vehicular applications. For example, in a vehicular application like for a car or truck, the trim cover assembly 10 may be provided on an interior trim component, such as a seat, door panel, instrument panel, or console. Examples of non-vehicular applications include seats, furniture, accessory bags, and clothing. In the discussion below, the trim cover assembly 10 will primarily be described in the context of a seat.

The trim cover assembly 10 may comprise at least a portion of an exterior surface of an article of manufacture. As such, the trim cover assembly 10 may provide a visible surface. A visible surface of the trim cover assembly 10 may include one or more decorative features, such as a groove, logo, or contoured surface. In various applications, a load force may be placed on the trim cover assembly 10, such as may occur when a seat occupant sits on a seat having a trim cover. It may be desirable to inhibit plastic deformation of a visible surface of the trim cover assembly (or other deformation from which the visible surface cannot recover) to inhibit creasing, wrinkling and/or bulging that may degrade aesthetic appearance and/or reduce seating comfort. Plastic deformation may result from a sufficiently high load force exerted against a surface of a trim cover that does not have sufficient plastic deformation inhibiting characteristics.

Referring to FIG. 1, a portion of the trim cover assembly 10 is shown in more detail. The trim cover assembly 10 may include a plurality of layers. The layers may be superimposed over each other; however, a layer may or may not completely separate two adjacent layers from each other.

The trim cover assembly 10 may include a first layer 20, a first bonding layer 22, a second layer 24, a second bonding layer 26, a third layer 28, a third bonding layer 30, and a fourth layer 32. The trim cover assembly 10 may be provided as a laminate in which the first, second, and third bonding layers 22, 26, 30 adhere or bond one or more layers 20, 24, 28, 32 together as will be discussed in more detail below. In addition, one or more of the layers may be omitted or repositioned in alternate embodiments.

The first layer 20 may provide at least a portion of an exterior or visible surface of the trim cover assembly 10. As such, the first layer 20 may include an exterior or first surface 40 and a second surface 42 disposed opposite the first surface. The first layer 20 may be made of any suitable material or materials, such as leather, vinyl, or fabric. In the discussion below, the first layer 20 is generally described in the context of a tanned leather skin.

The first bonding layer 22 may be disposed against or in direct physical contact with at least a portion of the first and second layers 20, 24. For instance, a first region or surface of the first bonding layer 22 may contact the second surface 42 and a second region or surface may contact the second layer 24. The first bonding layer 22 may attach, adhere, or bond the first layer 20 and the second layer 24 together. The first bonding layer 22 may be heat activated and may be configured as a heat activated adhesive web or resin. In addition, the first bonding layer 22 may be high frequency weldable and may be provided without bodying modifiers or blowing agents in one or more embodiments. The first bonding layer 22 may be configured to reach a softening, melting, and “stick points” above room temperature. For example, the first bonding layer 22 may be configured with a stick point in the range of about 60-90° C. and a melting point of about 80-110° C. The first bonding layer 22 may be made of any suitable material, such as a polymeric material like a copolyester thermoadhesive or a copolyamide. Examples of suitable first bonding layers 22 are Spunfab Ltd. product number PA1801 and Protechnic product number WEB 9L8.

Referring to FIGS. 1 and 2, the second layer 24 may be disposed between the first and third layers 20, 28, presuming that a third layer 28 is provided. For instance, the second layer 24 may include a first surface 50 that faces toward the first layer 20 and a second surface 52 disposed opposite the first surface 50. At least a portion of the first surface 50 may be in direct physical contact with the first bonding layer 22. Moreover, a portion of the first surface 50 may contact a portion of the first layer 20 in one or more embodiments. The second layer 24 may inhibit stretching of the first layer 20 while providing a desired level of flexibility. More specifically, the second layer 24 may help inhibit plastic deformation of the first layer 20 in cooperation with the first bonding layer 22 while permitting elastic deformation of the first layer 20. In at least one embodiment, plastic deformation of the first layer 20 may also be inhibited by placing the second layer in close physical proximity with the first layer rather than via separation by multiple intermediate layers.

The second layer 24 may be have a different configuration and/or may be made of one or more materials that differ from the first layer 20. For example, the second layer 24 may be provided as a cloth, fabric or woven material that may include a plurality of fibers and/or a plurality of materials. The second layer 24 may include a first material 60 and a second material 62 that differs from the first material 60. The first and second materials 60, 62 may be provided with different melting points to facilitate limited bonding of fibers during manufacture. In at least one embodiment, the first material 60 may be a polymeric material, such as polyester, and the second material 62 may be an organic material, such as cotton. Moreover, the second layer 24 may be composed of a greater quantity of the first material 60 or one or more materials having a lower melting point than the second material 62 to provide the opportunity to create physical bonds 64 in the first material 60 that may not be present before manufacture of the trim cover assembly 10. Such bonds may be provided in a majority of the composition of the second layer 24. For instance, the second layer 24 may include more than 50% of a polymeric material, such as polyester, and the remainder may be cotton. As such, the polymeric material may be melted or bonded together during manufacture while the cotton fibers do not melt together, thereby helping to maintain a desired level of flexibility. In another embodiment, the second layer 24 may be provided with different polymeric materials, such as polyester or PESF and viscose or CV. Such materials or fibers may have dissimilar or non-overlapping softening or melting temperature ranges. In at least one embodiment, at least one material may soften or melt in a temperature range that overlaps the activation temperature of one or more bonding layers 22, 26, 30.

The reinforcement qualities of the second layer 24 that may help inhibit plastic deformation of the first layer may also be affected by the type or “tightness” of the weave of the fabric. For instance, a tighter weave or greater thread density may help provide more load bearing fibers and/or more melting or bonding points between fibers than a looser weave or lower thread density. Resistance to tensile axial elongation, such as along a line or surface that does not intersect another layer, may be proportional to the tightness of the weave. An example of a suitable “tight weave” fabric is Greve & Co. KG product no. 50000 1983 0689/1500. An example of a suitable “loose weave” fabric is Kufner International product no. R171G46.

Referring again to FIG. 1, the second bonding layer 26 may be disposed in direct physical contact with at least a portion of the second and third layers 24, 28, presuming that a third layer 28 is provided. For instance, a first region or surface of the second bonding layer 26 may contact a region or surface of the second layer 24 that faces away from the first layer 20. The second bonding layer 26 may attach, adhere, or bond the second layer 24 and the third layer 28 together. The second bonding layer 26 may have the same configuration as the first bonding layer 22 and may be heat activated or may be configured as a heat activated adhesive web or resin. In addition, the second bonding layer 26 may be high frequency weldable and may be provided without bodying modifiers or blowing agents in one or more embodiments. The second bonding layer 26 may activate or adhere at similar temperatures and pressures as the first bonding layer 22.

The third layer 28 may be disposed between the second and fourth layers 24, 28, if provided. For instance, the third layer 28 may include a first surface 70 that faces toward the second layer 24 and a second surface 72 disposed opposite the first surface 70. At least a portion of the first surface 70 may be in direct physical contact with the second bonding layer 26. Moreover, a portion of the first surface 70 may contact a portion of the second layer 24 in one or more embodiments. The third layer 28 may be have a different configuration and/or may be made of a material that differs from that of the first and second layers 20, 24. The third layer 28 may be made of one or more materials that provide cushioning, such as foam.

The third bonding layer 30 may be disposed in direct physical contact with at least a portion of the third and fourth layers 28, 32, if provided. For instance a first region or surface of the third bonding layer 30 may contact a region or surface of the third layer 28 that faces away from the first layer 20. In addition, the third bonding layer 30 may attach, adhere, or bond the third layer 28 and the fourth layer 32 together. The third bonding layer 28 may have the same or similar configuration as the first and second bonding layers 22, 26 and may be heat activated or may be configured as a heat activated adhesive web or resin. In the embodiment shown, the third bonding layer 30 is shown with a different configuration than the first and second bonding layers 22, 26 to illustrate a bonding layer that may be provided with voids or gaps, such as may occur when a bonding layer is provided at discrete points or along different lines or areas that may or may not intersect. The third bonding layer 30 may activate or adhere at similar temperatures and pressures as the first and/or second bonding layers 22, 26.

The fourth layer 32, if provided, may be disposed proximate the third layer 28. For instance, the fourth layer 32 may include a first surface 80 that faces toward the third layer 28 and a second surface 82 disposed opposite the first surface 80. At least a portion of the first surface 80 may be in direct physical contact with the third bonding layer 30. Moreover, a portion of the first surface 80 may contact a portion of the third layer 28. In the embodiment shown, the second surface 82 is disposed opposite the first surface 40 of the first layer 20.

The fourth layer 32 may be have a different configuration and/or may be made of a material that differs from that of the first, second, and third layers 20, 24, 28. For example, the fourth layer 32 may be a woven or unwoven material, such as fleece, that helps provides cushioning. In at least one embodiment, the third and fourth layers 28, 32 may be preassembled or attached to each other before attachment to the second layer 24. Alternatively, the fourth layer 32 may be a coating or fabric layer that may help provide wear resistance. In a seating application, the second surface 82 may be disposed proximate or against a cushion that may be directly or indirectly supported by a support structure or frame. Alternatively, additional layers may be provided on the second surface 82 in one or more embodiments.

Referring to FIG. 3, a flowchart depicting an exemplary method of manufacture of the trim cover assembly 10 is provided.

At block 100, the components to be assembled may be provided. The components to be assembled may include the first layer 20, the first bonding layer 22 and the second layer 24. The second bonding layer 26 and third layer 28 may be provided in embodiments having a third layer 28. Similarly, the third bonding layer 30 and fourth layer 32 may be provided in embodiments having a fourth layer 32. The layers may be provided separately or one or more layers may be preassembled in any suitable combination. For example, the third layer 28, third bonding layer 30, and fourth layer 32 may be preassembled and provided as a subassembly laminate. One or more layers may be provided as a sheet and may be provided on a roll to facilitate high volume production. In addition, one or more bonding layers 22, 26, 30 may be provided with or as part of another material or layer. For instance, the first or second bonding layers 22, 26 may be preassembled or provided as part of the second layer 24.

At block 102, the components may be configured to a predetermined size and/or shape. For instance, a first layer 20, such as a leather layer, may be cut to a desired shape or attached to other leather or non-leather pieces in any suitable manner to preassemble the first layer 20. Similarly, one or more of the other layers 22, 24, 26, 28, 30, 32 may be cut, shaped, or formed to a desired configuration. This step may be omitted or performed later in the process, such as after block 104 or 106 in one or more embodiments.

At block 104, the components may be positioned with respect to each other. The layers may be placed in a predetermined sequence. For instance, the first bonding layer 22 may be positioned adjacent to the first layer 20, the second layer 24 may be positioned adjacent to the first bonding layer 22, the second bonding layer 26 may be placed adjacent to the second layer 24, and so on. One or more layers may be manually positioned or positioned via automation. For instance, one or more layers may be unrolled and routed in close physical proximity to each other in a continuous flow assembly process.

At block 106, the components may be joined (e.g., attached, adhered, bonded together). In at least one embodiment, heat and pressure may be provided to activate the bonding layers 22, 26, 30 at approximately the same time. The amount of heat and pressure applied may be configured to active one or more bonding layers 22, 26, 30. The heat and/or pressure that activate the bonding layers may also melt or fuse together fibers in the second layer 24. As such, the tensile strength of the second layer 24 may increase from its original condition when the materials are joined due to the attachment or fusing together of individual fibers.

Heat and pressure may be provided in any suitable manner. For instance, the components may be positioned in a press having first and second dies or contact surfaces. The first and second contact surfaces may be heated. In addition, the first and second contact surfaces may be heated to different temperatures. In an embodiment having a leather first layer 20, the contact surface that contacts the first layer 20 may be heated to a lower temperature than the other contact surface to prevent heat damage to the first layer 20. In a continuous flow assembly process, the components may pass one or more sets of rollers help position and apply pressure to the layers. A set of rollers may be heated to apply the desired level of thermal energy. In addition, different rollers may be heated to different temperatures similar to the press embodiment described above.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A trim cover assembly comprising:
a first layer having a first surface and a second surface disposed opposite the first surface; and
a second layer bonded against the second surface;
wherein the second layer inhibits plastic deformation of the first layer.

2. The trim cover assembly of claim 1 wherein the first layer is leather.

3. The trim cover assembly of claim 1 further comprising a first bonding layer disposed against the second surface and the second layer, wherein the second layer is a fabric and the first bonding layer is a heat activated bonding agent.

4. The trim cover assembly of claim 3 wherein the second layer includes a first material and a second material that differs from the first material, wherein the first material is configured to melt when the heat activated bonding agent is activated to adhere the first and second layers together.

5. The trim cover assembly of claim 3 wherein the second layer includes a first material that is an organic fiber and a second material that is a polymer.

6. The trim cover assembly of claim 5 wherein the first material is cotton and the second material is polyester.

7. The trim cover assembly of claim 1 wherein the second material includes a first set of fibers made of a first material and a second set of fibers made of a second material that differs from the first material, wherein at least a portion of the members of the first set of fibers are bonded to each other to form at least one point of attachment that inhibits tensile stretching of the first layer.

8. The trim cover assembly of claim 1 further comprising a third layer laminated to the second layer via a second bonding layer.

9. The trim cover assembly of claim 8 wherein the third layer is a foam.

10. The trim cover of claim 8 further comprising a fourth layer laminated to the third layer via a third bonding layer.

11. The trim cover of claim 10 wherein the fourth layer is a fleece material.

12. The trim cover assembly of claim 8 wherein the first layer is leather, the second bonding layer is a heat activated adhesive resin, and the third layer is a fabric, wherein the second bonding layer and third layer cooperate to permit elastic deformation of the first layer and inhibit plastic deformation of the first layer, and wherein resistance to tensile axial elongation is proportional to the tightness of the weave of the fabric.

13. A method of making a trim cover assembly comprising:
providing a first layer, a first bonding layer, and a second layer having a polymeric material;
positioning the first bonding layer between the first and second layers; and
applying heat and pressure to activate the polymeric material to adhere the first bonding layer to the first and second layers;
wherein the second layer and the first bonding layer cooperate to permit elastic deformation of the first layer while inhibiting plastic deformation of the first layer.

14. The method of claim 13 wherein the step of applying heat and pressure includes applying a first level of heat to a first surface of the first layer and applying a second level of heat to a surface of the trim cover assembly disposed opposite the first surface, wherein the first level of heat is less than the second level of heat.

15. The method of claim 13 wherein the step of providing a first layer includes cutting the first layer to a predetermined shape.

16. The method of claim 13 wherein the second layer includes a first material and a second material that differs from the first material, and wherein the step of applying heat and pressure further comprises fusing together at least a portion of the first material.

17. The method of claim 13 wherein the second layer includes a first fiber material and a second fiber material that differs from the first fiber material and wherein the step of applying heat and pressure further comprises melting together at least a portion of fibers of the first fiber material without melting together fibers of the second fiber material.

18. The method of claim 13 wherein tensile strength of the second layer increases after heat and pressure are applied.

19. The method of claim 13 further comprising providing a second bonding layer adjacent to the second layer, a third layer adjacent to the second bonding layer, a third bonding layer adjacent to the third layer, and a fourth layer, wherein heat and pressure are applied to the first layer and the fourth layer to bond the layers together.

20. A trim cover assembly comprising:
a first layer;
a first bonding layer bonded to the first layer;
a second layer bonded to the first bonding layer;
a second bonding layer bonded to the second layer;
a third layer bonded to the second bonding layer;
a third bonding layer bonded to the third layer; and
a fourth layer bonded to the third bonding layer;
wherein the second layer and first bonding layer cooperate to inhibit plastic deformation of the first layer and wherein the third and fourth layers provide cushioning.
